(19) United States
(12) Patent Application Publication
(10) Pub. No.: US 2016/0058064 A1
(43) Pub. Date: Mar. 3, 2016

(54) STRAWBERRY CAPPER

(71) Applicant: Meduri Farms, Inc., Dallas, OR (US)

(72) Inventors: Joseph J. MEDURI, Dallas, OR (US); Devin Patrick DONAHUE, Keizer, OR (US); Christopher Michael IMDIEKE, Molalla, OR (US)

(73) Assignee: MEDURI FARMS, INC., Dallas, OR (US)

(21) Appl. No.: 14/475,380

(22) Filed: Sep. 2, 2014

(51) Int. Cl. A23N 15/02

(52) U.S. Cl. CPC A23N 15/02

(57) ABSTRACT

Devices and methods for mechanically removing portions of individual pieces of produce may include a conveyor configured to transport pieces of produce from an upstream end portion to a downstream end portion on a plurality of spaced, elongate teeth, and a blade assembly disposed at the downstream end portion of the conveyor. The blade assembly may include a cutting edge configured to pass generally parallel to the elongate teeth at a selected distance such that a desired portion of each piece of the retained produce is removed by the cutting edge. The disclosed devices and methods may be particularly well suited for removing the stem or cap portions of strawberries.

### FIELD

This disclosure relates to systems and methods for processing produce. More specifically, the disclosed embodiments relate to systems and methods for removing portions of fruits and/or vegetables.

### BACKGROUND

Strawberries and other fruits are used in various food products, the popularity of which has grown significantly over the past several years. Frequently, whole strawberries are divided into portions for separate processing. For example, a cap portion of the strawberry, containing the stem and leaves of the fruit, may be suitable for use in certain products or processes, but is not generally eaten by consumers. Conversely, the body portion of the strawberry can be eaten as is, frozen, dried, sliced, pureed, or otherwise further processed as needed. Devices and methods are therefore desirable for initial processing of produce such as strawberries.

### SUMMARY

The present disclosure provides an apparatus for mechanically removing portions of individual pieces of produce, the apparatus including a first conveyor defining an upstream end portion and a downstream end portion and configured to transport pieces of produce from the upstream end portion to the downstream end portion; a plurality of elongate teeth spaced from each other at substantially regular intervals along the first conveyor and configured to retain a piece of the produce in a selected orientation between each pair of adjacent teeth; and a blade assembly disposed at the downstream end portion of the first conveyor and including a cutting edge configured to pass generally parallel to the elongate teeth at a selected distance such that a desired portion of each piece of the retained produce is removed by the cutting edge.

In some embodiments of the present teachings, an apparatus for processing produce may include a supply conveyor for conveying produce, the supply conveyor defining a supply conveyance path; a comb conveyor adjacent to the supply conveyor, the comb conveyor including a plurality of teeth spaced apart along a length of the comb conveyor, the comb conveyor configured to transport a plurality of pieces of produce each impaled onto one or more of the teeth along a processing conveyance path generally parallel to the supply conveyance path; and a cutting device disposed at one end of the comb conveyance path, the cutting device including at least one cutting surface configured to remove a portion of each impaled piece of produce by passing a selected distance from the teeth of the comb conveyor.

In some embodiments, a processing system according to the present teachings may include a first conveyor having a substantially planar conveyance surface travelling along a first conveyance path; a second conveyor laterally adjacent to the first conveyor, the second conveyor having a plurality of spaced-apart elongate projections travelling along a second conveyance path parallel to and co-directional with the first conveyance path, each adjacent pair of the elongate projections configured to retain a strawberry impaled therebetween; and a rotating cutter disposed at a downstream end portion of the second conveyor and spaced from the elongate projections such that rotation of the cutter removes a predetermined amount of the strawberry as the teeth pass by the cutter.

While the embodiments described below refer primarily to processing strawberries, more generally the present teachings may be applied to any fruit or vegetable where it is desirable to separate an end or cap portion of the produce from its remaining portions. The features, functions, and advantages of the present teachings may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative strawberry capping system in accordance with aspects of the present disclosure.

FIG. 2 is an elevation view of a downstream end portion of an illustrative strawberry capping system in accordance with aspects of the present disclosure.

FIG. 3 is a plan view of the system shown in FIG. 2.

FIG. 4 is a plan view of an upstream portion of the system shown in FIG. 2.

FIG. 5 is a magnified detail view of an illustrative comb conveyor and shear plate in accordance with aspects of the present disclosure.

FIG. 6 is a sectional end view of the system shown in FIG. 2, showing illustrative relationships between various structures and conveyor components.

FIG. 7 is a partial elevation view of an illustrative cutting assembly in accordance with aspects of the present disclosure, showing an alternative arrangement of a drive and cutter.

FIG. 8 is a side view of another illustrative arrangement of a cutting assembly in accordance with aspects of the present disclosure, showing an adjustable comb conveyor and relationships between various components and a piece of fruit carried on the conveyor.

FIG. 9 is an overhead view of an illustrative cutting assembly in relation to a comb conveyor in accordance with aspects of the present disclosure.

FIG. 10 is a flow chart illustrating steps of a method for capping strawberries in accordance with aspects of the present disclosure.

### DESCRIPTION

### Overview

Various embodiments of a produce processor are described below and illustrated in the associated drawings. Unless otherwise specified, a produce processor and/or its various components may, but are not required to, contain at least one of the structure, components, functionality, and/or variations described, illustrated, and/or incorporated herein. Furthermore, the structures, components, functionalities, and/or variations described, illustrated, and/or incorporated herein in connection with the present teachings may, but are not required to, be included in other systems, devices, and methods for processing produce. The following description of various embodiments is merely exemplary in nature and is in no way intended to limit the disclosure, its application, or uses. Additionally, the advantages provided by the embodiments, as described below, are illustrative in nature and not all embodiments provide the same advantages or the same degree of advantages.

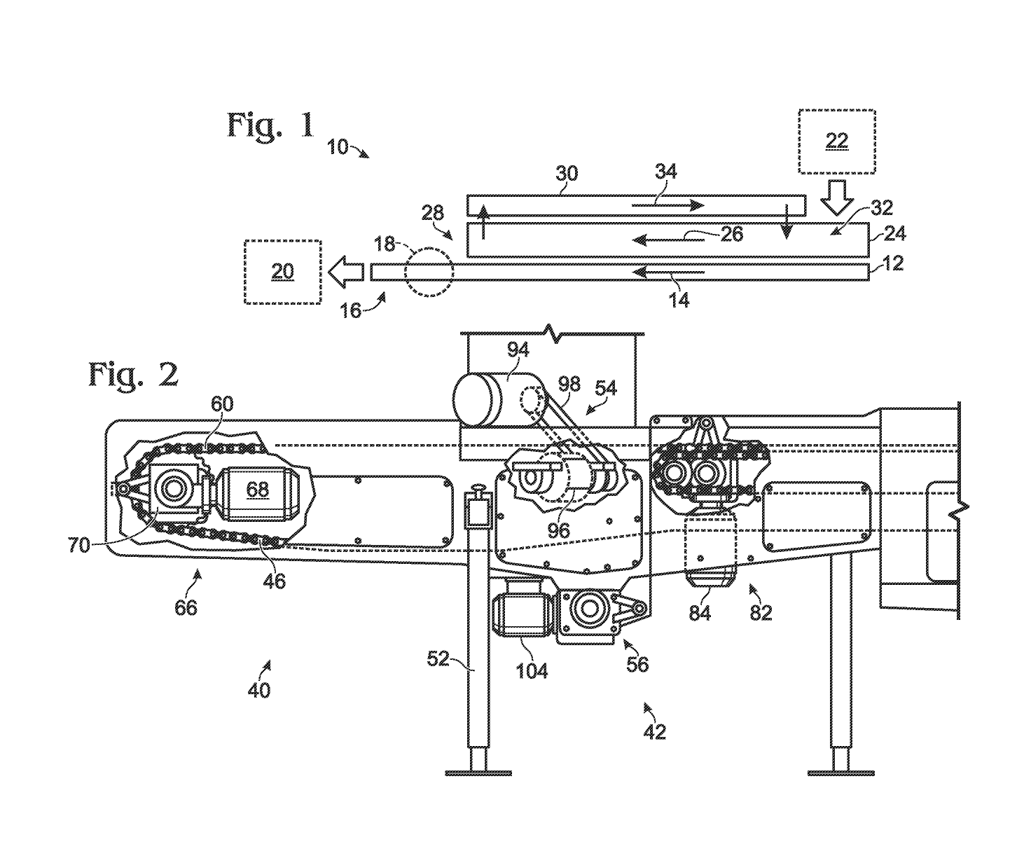

Referring now to the schematic diagram of FIG. 1, one embodiment of a strawberry capper according to the present teachings is generally indicated at 10. Strawberry capper 10 may include a first conveyor 12 defining a first conveyance path configured to transport produce in a first direction 14. Conveyor 12 may include any suitable apparatus or system configured to move pieces of vegetables and/or fruit (e.g., strawberries) toward a downstream end portion 16, while also holding the pieces in a desired orientation. For example, conveyor 12 may be configured transport a piece of fruit (e.g., a strawberry) with the stem side pointing down.

Strawberry capper 10 may further include a cutting assembly 18 disposed at or adjacent to downstream end portion 16 of conveyor 12. Cutting assembly 18 may include any suitable device configured to remove a portion of each piece of produce that passes by on the conveyor. Cutting assembly 18 may include any suitable cutting device, and may include one or more cutting surfaces (e.g., edges, blades) that move in a manner described as rotating, rotary, reciprocating, oscillating, spinning, sinusoidal, and/or the like, or any combination of these. Motion of the cutting surface(s) may be continuous, intermittent, and/or discrete. In some examples, the cutting surface(s) may remain stationary or fixed for some or all of the operating cycle. While removal of a portion of the produce is described herein as cutting, such removal may additionally or alternatively be accomplished by grinding, slicing, scraping, shearing, and/or the like.

Accordingly, cutting assembly 18 may include a moving blade or knife having a cutting edge, and may be referred to as a blade assembly and/or a knife assembly. Cutting assembly 18 may be configured to pass cutting edge of the blade near conveyor 12, thereby removing a portion of the piece of produce held thereon in a selected orientation. By selecting the produce orientation, number of blades, blade-to-conveyor distance, and relative speeds of the conveyor and cutting assembly, a predetermined portion of each piece of produce may be reliably and repeatably removed. Cutting of the predetermined portion may be referred to as “capping,” for example, when removing a “cap” from a strawberry “body.” Cutting of the predetermined portion may also be referred to as “topping,” for example, when removing a “top” from a strawberry. The cap or top includes a portion of the stem end of the fruit, which may also be referred to as a calyx portion. More generally, virtually any type of produce may be “capped” or “topped” using aspects of the present teachings.

Strawberry capper 10 may include a receptacle 20 disposed at downstream end 16 and configured to receive the uncut or body portions of the pieces of produce following interaction with the cutting assembly. Receptacle 20 may include any suitable structure configured to catch or receive pieces of produce. The body portions of the produce may be urged off of conveyor 12 toward receptacle 20. For example, a pusher device may actively force the produce off the conveyor. In other examples, a shear plate may progressively narrow the conveyor path such that the bodies of the pieces of produce fall off the conveyor as they pass the plate.

Strawberry capper 10 may be loadable, fillable, or chargeable by adding pieces of produce such as strawberries to conveyor 12. The loading process may be manual, automated, semi-automated, machine-assisted, and/or the like, or any combination of these. For example, pieces of fruit may be obtained from a hopper or other container 22 and loaded onto conveyor 12 manually by a user. In some examples, obtaining the produce from container 22 may be automated or assisted, such as by a mechanical dumping device that tips the hopper, spilling its contents onto an area easily accessible by the user.

In other examples, such as that shown schematically in FIG. 1, a second conveyor 24 may be included to further assist the user or users in loading the first conveyor with produce. Second conveyor 24 may include any suitable device configured to transport the pieces of produce in bulk form along a second conveyor path in a direction 26. Direction 26 may be substantially parallel to direction 14 of the first conveyor path. Second conveyor 24 may include a belt conveyor, and/or may be arranged within arm's length of the first conveyor such that users or operators may reach the second conveyor to obtain produce and load the first conveyor.

Second conveyor 24 may operate at the same conveyance speed as first conveyor 12, or at a different speed. For example, second conveyor 24 may operate at a speed that is slower than the speed of first conveyor 12. This may be desirable, for example, if the capacity of second conveyor 24 is greater than the capacity of first conveyor 12, allowing more of the contents of conveyor 24 to be loaded onto conveyor 12 as both pass by a user. In other examples, the capacities and/or relative speeds may be swapped. In some examples, the speed of one or both conveyors may be adjustable, such as in the case of a variable speed conveyor.

Regardless of relative speeds, some produce being transported by second conveyor 24 may reach a downstream end 28 of the conveyor without being relocated to the first conveyor. Accordingly, such produce may be urged, forced, or otherwise displaced onto a third conveyor 30 configured to return the produce to an upstream end portion 32 of second conveyor 24. Third conveyor 30 may define a third conveyance path travelling in a direction 34 parallel and opposite to direction 26 of the second conveyor.

First conveyor 12 may be referred to as a processing conveyor and/or a positioning conveyor. Second conveyor 24 may be referred to as a supply conveyor and/or a bulk conveyor. Third conveyor 30 may be referred to as a return conveyor.

Each of the conveyors described above may include any suitable conveyance devices or systems, including belt conveyors, roller conveyors, continuous loop conveyors, vibration conveyors, reciprocating conveyors, slat conveyors, chain conveyors, comb conveyors, and/or the like, or any combination of these. Furthermore, each conveyor may be configured with a support surface for supporting objects transported by the respective conveyor. The support surface may be continuous, noncontinuous, planar, and/or nonplanar. Support may be accomplished by providing a horizontal support from below, a hanging interface from above or the side, and/or a shaped or articulated support from an arbitrary or selected direction, such as by impaling or clamping of the transported object.

### Specific Examples, Major Components, and Alternatives

The following examples describe selected aspects of exemplary produce processing systems, devices, and methods, according to aspects of the present teachings. These examples are intended for illustration and should not be interpreted as limiting the entire scope of the present disclosure. Each example may include one or more distinct inventions, and/or contextual or related information, function, and/or structure.

### EXAMPLE 1

This example describes an illustrative strawberry capper system having a processing conveyor for carrying strawberries toward a topping area, a supply conveyor for facilitating bulk loading of the system, a return conveyor for recirculating fruit that was not transferred from the supply conveyor to the processing conveyor, a rotational blade assembly for topping the strawberries, an auger assembly for receiving the removed tops, and various other associated components; see FIGS. 2-9.

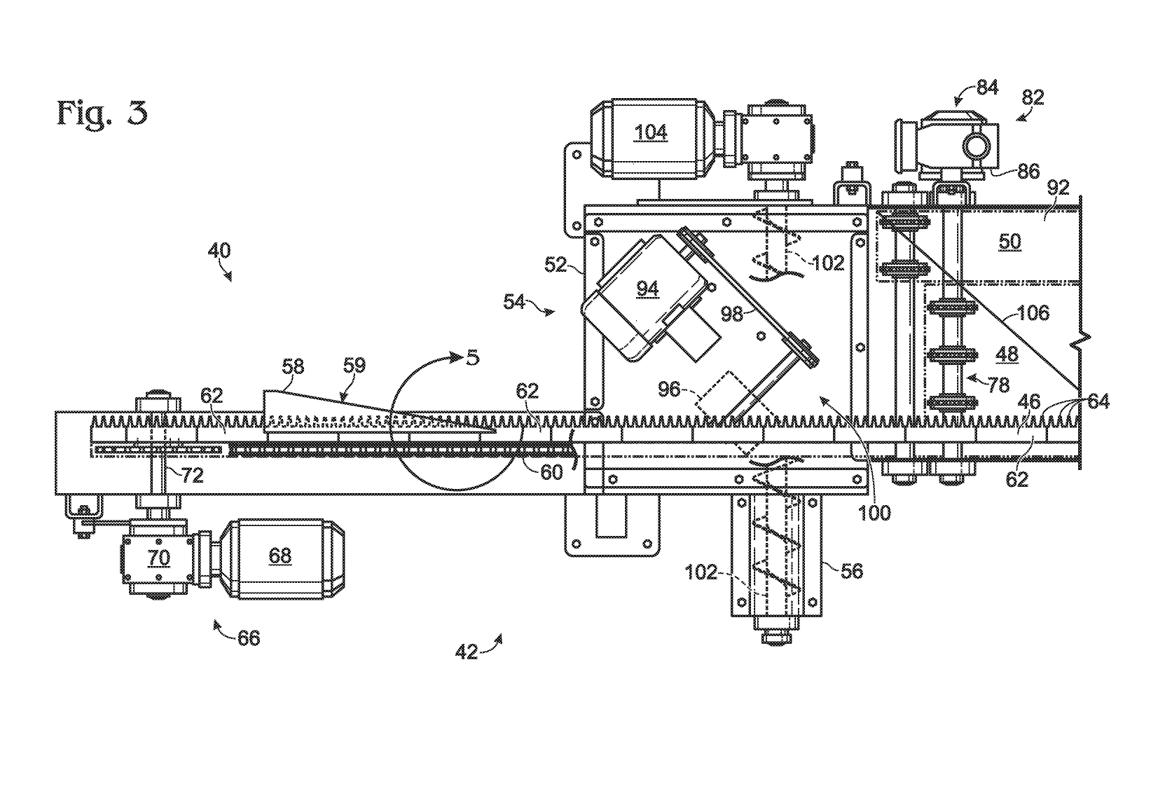

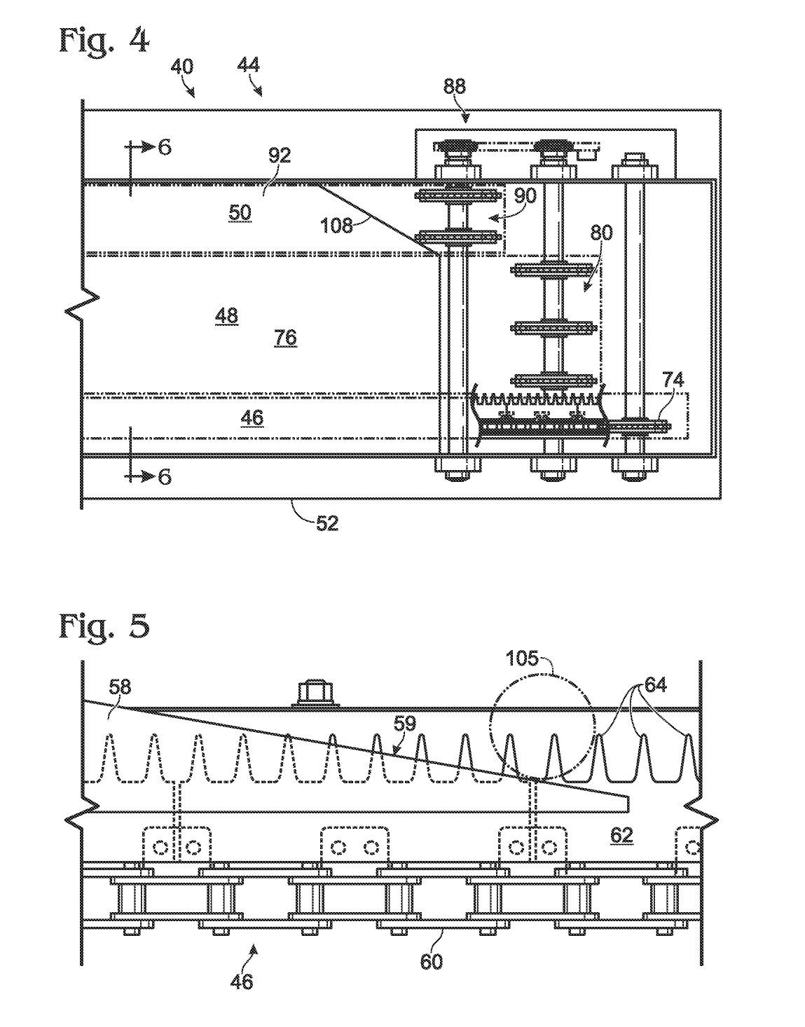

In this example, an illustrative strawberry capper system is shown in the drawings and generally indicated at 40. FIG. 2 is an elevation view of a downstream end portion 42 of system 40. FIG. 3 is an overhead plan view of the downstream end portion, and FIG. 4 is an overhead plan view of an upstream end portion 44 at the opposite end of system 40. A middle portion of system 40 may lie between end portions 42 and 44, and that the middle portion may be an extension of the components shown in the drawings. The middle portion may extend for any suitable length and along any suitable path configured to join end portions 42 and 44. Overall, system 40 may have any length and height that is suitable for a desired number of users to stand along the system safely without mutual interference, and to manually interact with the produce. For example, system 40 may be approximately 50-60 feet in length and approximately 36-39 inches in height at the conveyors. Other dimensions may be appropriate, and the system may be adjustable in length and/or height.

With continuing reference to FIGS. 2-4, system 40 includes a first conveyor 46 (also referred to as a comb conveyor and/or a processing conveyor), a second conveyor 48 (also referred to as a bulk conveyor and/or a first belt conveyor), generally parallel and adjacent to the first conveyor, and a third conveyor 50 (also referred to as a return conveyor, recycling conveyor, and/or recycler), generally parallel and adjacent to the second conveyor. Conveyors 46, 48, and 50 are supported by a common support structure 52 including a frame, a plurality of legs, various structural and aesthetic panels, and guards. Downstream end portion 42 includes a topping assembly 54 for removing tops of strawberries, an auger assembly 56 for receiving the tops, and a shear plate 58 for removing bodies of strawberries from the first conveyor. Various drives and controls are associated with the above-described components, as will be described in further detail below.

First conveyor 46 includes a sprocket-driven chain 60. A plurality of comb plates 62 are attached along the length of chain 60, each comb plate including a plurality of teeth 64, also referred to as tines, spikes, and/or spindles. Teeth 64 are spaced apart from each other at regular intervals, and are oriented perpendicular to the conveyance path, such that points of the teeth at least partially overhang second conveyor 48. Note that teeth 64 may be horizontal, such that the teeth are oriented parallel to the conveyance surface of the second conveyor, or may be at an angle other than horizontal.

A user will typically stand on a side of system 40 such that teeth 64 point generally away from the user. Each comb plate may comprise any suitable material and may include any suitable configuration facilitating placement thereon of strawberries by a user, where the strawberries are fixed in place on conveyor 46 by being impaled on one or more teeth, impaled on or friction-fit between two successive teeth, and/or any combination of these. In one embodiment, each comb plate may be a stainless steel plate approximately 5.75 inches long by approximately 2 inches wide, with about ten approximately 13/16-inch teeth protruding from a long edge, the teeth spaced approximately ⅝-inch apart as measured from tip to tip, such that the comb plate overall is approximately 5.75 inches long by approximately 2.8125 inches wide. Each such plate may be affixed to conveyor chain 60, such as by bolting or otherwise fastening the plate to one or more links in the chain. Mounting plates or flanges may be provided on the chain for this purpose. Gaps are disposed on opposite ends of each plate, such that the chain may loop continuously even though each of the plates is substantially rigid.

Chain 60, also referred to as the comb chain, is driven by a drive unit 66 including an electric motor 68 operatively connected to a reduction gear 70, also referred to as a gearbox, and thereby to a driveshaft 72, on which is a drive sprocket that meshes with chain 60 to impart motion. Any suitable motor or other prime mover may be used. In some embodiments, drive unit 66 may include a variable frequency drive (VFD), such that the speed of conveyor 46 may be controlled and adjusted. At upstream end portion 44, chain 60 may turn around at a tail pulley or tail sprocket 74.

Second conveyor 48 includes a belt portion 76, which may include a continuous, semi-continuous (e.g., parallel slats), and/or non-continuous belt looped around a head pulley 78 at downstream end portion 42 and a tail pulley 80 at upstream end portion 44. Conveyor 48 is driven by a drive unit 82 similar to drive unit 66, including a drive motor 84 operatively connected to a reduction gear unit 86 and the shaft of head pulley 78. As described above, drive unit 82 may include a VFD for speed control.

Third conveyor 50, which is the return conveyor for second conveyor 48, runs parallel to the second conveyor and in an opposite direction. Accordingly, system 40 takes advantage of the adjacency of the two conveyors and both are driven by drive unit 82. A gear assembly 88 at upstream end portion 44 links the two conveyors and reverses the motion of second conveyor 48 by operatively connecting tail pulley 80 with drive pulley 90 of the return conveyor. Third conveyor 50 includes a belt portion 92 similar to belt 76.

Topping assembly 54, also referred to as a capping assembly and/or cutting assembly, includes a drive motor 94 coupled to a rotating blade assembly 96 by a belt or chain 98. As shown in FIGS. 2 and 3, drive motor 94 may be offset from the rotating blade assembly. In other embodiments, such as the one shown in FIG. 7, drive motor 94 may be mounted directly over blade assembly 96. Blade assembly 96 is oriented such that the one or more cutting blades or knives of the blade assembly pass under comb conveyor 46 in a direction transverse to the conveyance path of the conveyor and with a component of each blade's velocity vector pointing perpendicular to the long axis of the comb conveyor and toward the bases of the teeth as the blade passes in close proximity to the teeth of the comb conveyor. This arrangement facilitates cutting or scraping in the topping operation, because force imparted on the fruit by the blade pushes the fruit further into a secured position while cutting. A component of the blade's velocity vector pointing in a direction opposite the conveyance path of the comb conveyor also assists in the efficient topping of the fruit by adding the force of conveyance to the force of cutting or scraping, resulting in a shearing effect on the fruit.

Tops of fruit removed by topping assembly 54 are directed by gravity and imparted force from the blade assembly to auger assembly 56 disposed below and/or around the blade assembly. A hopper 100 of auger assembly 56 receives the fruit tops and an auger 102 driven by an auger drive unit 104 helically urges, forces, pushes, and/or squeezes the fruit tops toward an outlet opening of the hopper and into an underlying receptacle for further processing or disposal as desired.

With continued reference to FIGS. 2-4, and with additional reference to the detailed view of FIG. 5, shear plate 58 includes a shear surface passing across the conveyance path defined by first conveyor 46 at a transverse angle, downstream of topping assembly 54. In other words, shear plate 58 includes a wall or similar surface 59 that crosses the comb conveyor in a way that causes each piece of produce 105 carried by the comb conveyor to strike the wall as the conveyor passes under or through the wall. In other words, the shear plate causes the conveyance path to progressively taper down or narrow toward one side. This narrowing urges, pushes, and/or forces the fruit off the teeth of the comb conveyor. The shear plate is disposed at downstream end portion 42 downstream of conveyors 48 and 50 and the topping assembly. Accordingly, the bodies of the produce may fall from the first conveyor toward an underlying receptacle, facilitating further disposition such as by additional processing or disposal.

Similar to shear surface 59 of shear plate 58, shear surfaces 106 (see FIGS. 3) and 108 (see FIG. 4) are included at the downstream ends of second conveyor 48 and third conveyor 50, respectively. These shear plates function with the conveyors to impart a similar side force on the fruit being transported. Each of these shear plates is configured to cause fruit to pass between the second and third conveyors without user intervention, thereby facilitating recirculation of produce that has not yet been placed on the teeth of the first conveyor.

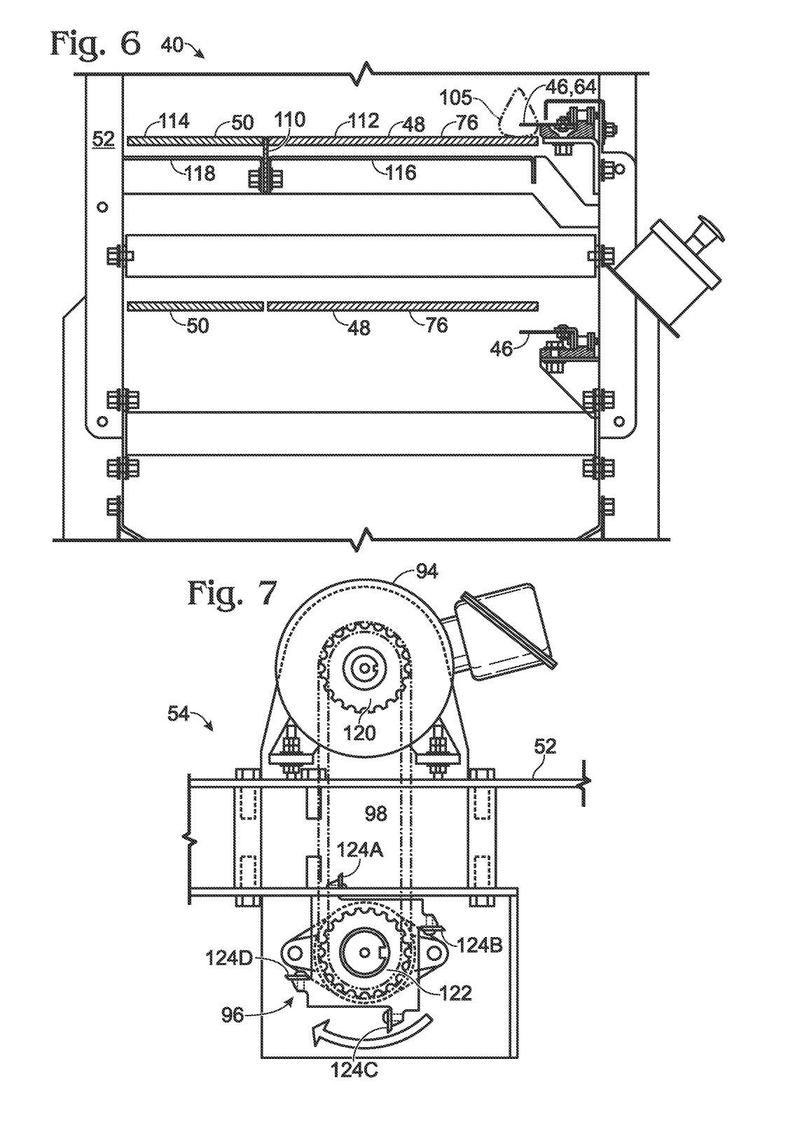

FIG. 6 is a sectional end view of system 40, taken along the line 6-6 in FIG. 4, showing the relative arrangement of the various conveyors. As shown in the drawing, a wall or divider 110 separates conveying portion 112 of second conveyor 48 from conveying portion 114 of recirculation conveyor 50 as the conveyors ride atop respective conveyor beds 116 and 118. FIG. 6 also shows that comb conveyor 46 travels above conveying portion 112 of second conveyor 48, and the teeth of the comb conveyor partially overlap belt 76 at a certain height. An exemplary piece of produce 105 in the form of a strawberry is shown in phantom to indicate placement of the fruit on the teeth, and to show that a calyx portion of the fruit is held between the teeth and in contact with the belt of conveyor 46. This positioning allows a known orientation and known segment height to be selected consistently before topping. The amount of produce removed in the topping process can be predetermined, and can be adjusted by changing the height of the teeth above the conveyor belt.

FIG. 7 is a side view of drive unit 94 and blade assembly 96, shown in an alternative arrangement with the drive unit disposed directly above the blade assembly. Drive gear 120 is rotated by drive unit 94, and motion is transferred to blade assembly gear 122 by drive chain 98. Blade assembly 96 includes four cutting blades or knives 124A-124D configured to rotate about a common axis.

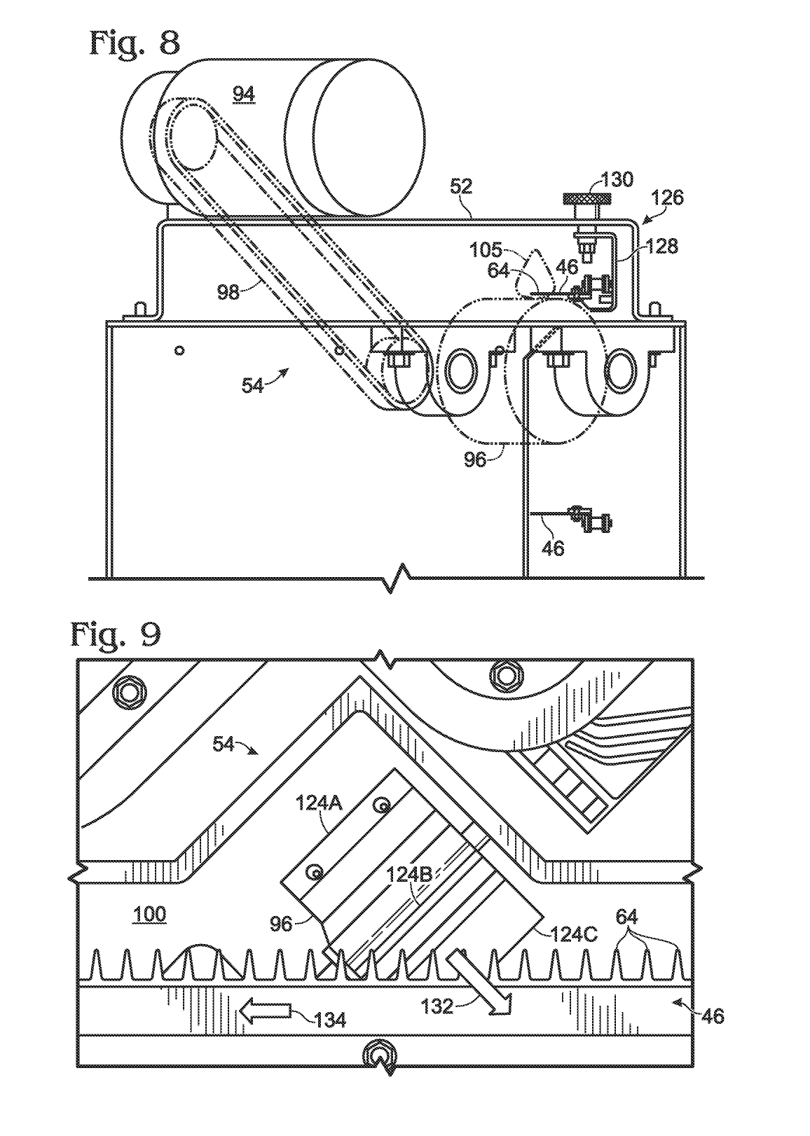

FIG. 8 is a sectional side view of drive unit 94 and blade assembly 96 in the offset arrangement of FIGS. 2-3, showing the relationship between passing produce (depicted as a strawberry 105) and the path of the blade assembly. Conveyor 46 may also be adjustable in height relative to the blade assembly, such as by way of a height adjustment assembly 126. Height adjustment assembly includes a bracket and support 128 on which the comb conveyor rides, operatively connected to a screw-type height adjustment knob 130 that is configured to raise and lower the bracket and thereby the conveyor relative to support structure 52 (and thus relative to blade assembly 96).

FIG. 9 is an overhead view of blade assembly 96 and comb conveyor 46, showing the direction of rotation 132 of the blade assembly relative to the direction 134 of the conveyor.

### EXAMPLE 2

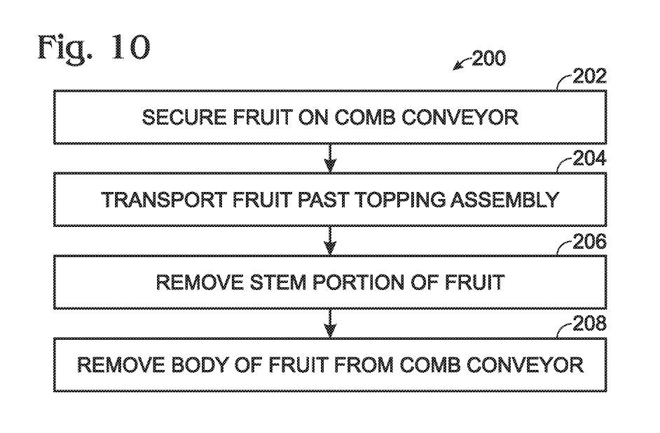

This example describes steps of a method for removing stem, end, or cap portions of produce such as strawberries, among others; see FIG. 10.

FIG. 10 is a flowchart illustrating steps performed in an illustrative method, and may not recite the complete process or all steps of the process. FIG. 10 depicts multiple steps of a method, generally indicated at 200, which may be performed according to aspects of the present disclosure. Although various steps of method 200 are described below and depicted in FIG. 10, the steps need not necessarily all be performed, and in some cases may be performed in a different order than the order shown.

At step 202 pieces of produce (e.g., strawberries) are secured on a comb conveyor such as the one described above. For example, a hopper or other supply source of strawberries may be loaded onto a comb conveyor individually. The loading may be manual, such as by a user manually selecting strawberries from a container and placing them onto the teeth of the comb conveyor as it passes by. The loading may be assisted, such as when a supply conveyor is used, carrying the supply of produce past the user.

The comb conveyor may be arranged at a height above the supply conveyor such that the user can slide strawberries, stem side down, onto the teeth with the stem side of the strawberry still touching the supply conveyor. This gives the user a guide or gauge regarding placement of the strawberries for proper processing downstream. Strawberries may be secured on the comb conveyor by impaling them onto and/or between teeth. Fruit that does not get secured onto the comb conveyor may recirculate to the upstream end of the supply conveyor via a return conveyor. Relative speeds of the conveyors may be controllable to minimize recirculation, such as by running the supply conveyor slower than the comb conveyor.

At step 204, the secured produce is transported to and past an adjacent topping assembly. For example, the secured produce may be conveyed over a cutting assembly that removes an end portion, such as a top, cap or stem, of each piece of produce. The cutting assembly may be arranged and oriented relative to the comb conveyor depending on the expected orientation and placement of the produce pieces. For example, if the produce pieces are to be held stem-down, then the cutting assembly may be located under the comb conveyor to interface with the stem end of the produce.

At step 206, a portion of each piece of produce is removed by cutting, slicing, grinding, scraping, and/or the like. As described above, the cutting assembly may include one or more knives or cutting edges that are passed near the comb conveyor and through each piece of produce. The uncut bodies of the produce pieces may remain secured on the comb conveyor, while the tops or removed portions may fall or otherwise enter into a receptacle disposed nearby for this purpose. An auger or other device may then transport the tops to a collection point for further processing or disposal.

At step 208, the bodies remaining secured to the comb conveyor are removed and received into a receptacle for further processing. For example, the comb conveyor may pass by or through a shear plate as described above, urging each body portion of produce in a direction perpendicular to the direction of conveyance and off the teeth into the receptacle. In other examples, the produce bodies may be pushed, pulled, shaken, and/or released by any other suitable method. For example, produce may be removed from the teeth manually by a user.

### EXAMPLE 3

This section describes additional aspects and features of produce processors such as strawberry cappers, presented without limitation as a series of numbered paragraphs. Each of these paragraphs can be combined with one or more other paragraphs, and/or with disclosure from elsewhere in this application in any suitable manner. Some of the paragraphs below expressly refer to and further limit other paragraphs, providing without limitation examples of some of the suitable combinations.

A0. An apparatus for mechanically removing portions of individual pieces of produce, the apparatus including:
a first conveyor defining an upstream end portion and a downstream end portion and configured to transport pieces of produce from the upstream end portion to the downstream end portion;
a plurality of elongate teeth spaced from each other at substantially regular intervals along the first conveyor and configured to retain a piece of the produce in a selected orientation between each pair of adjacent teeth; and
a blade assembly disposed at the downstream end portion of the first conveyor and including a cutting edge configured to pass generally parallel to the elongate teeth at a selected distance such that a desired portion of each piece of the retained produce is removed by the cutting edge.

A1. The apparatus of A0, further including a second conveyor parallel to the first conveyor, the second conveyor configured to transport pieces of produce not retained by the teeth from the downstream end portion of the first conveyor back to the upstream end portion of the first conveyor.

A2. The apparatus of A0, further comprising a third conveyor adjacent and parallel to the first conveyor, the third conveyor configured to transport pieces of produce on a planar conveyance surface alongside the first conveyor.

A3. The apparatus of A2, wherein long axes of the plurality of elongate teeth are oriented generally parallel to the conveyance surface of the third conveyor.

A4. The apparatus of A2, wherein the plurality of elongate teeth at least partially overhang the conveyance surface of the third conveyor.

A5. The apparatus of A0, wherein the blade assembly is rotatable.

A6. The apparatus of A5, wherein an axis of rotation of the blade assembly is parallel to the cutting edge.

A7. The apparatus of A0, wherein the cutting edge of the blade assembly is configured to pass through each piece of retained produce generally toward proximal ends of the teeth.

B0. An apparatus for processing produce, the apparatus comprising:
a supply conveyor for conveying produce, the supply conveyor defining a supply conveyance path;
a comb conveyor adjacent to the supply conveyor, the comb conveyor including a plurality of teeth spaced apart along a length of the comb conveyor, the comb conveyor configured to transport a plurality of pieces of produce each impaled onto one or more of the teeth along a processing conveyance path generally parallel to the supply conveyance path; and
a cutting device disposed at one end of the comb conveyance path, the cutting device including at least one cutting surface configured to remove a portion of each impaled piece of produce by passing a selected distance from the teeth of the comb conveyor.

B1. The apparatus of B0, wherein the cutting device is further configured such that each tooth of the comb conveyor is passed by at least one cutting surface as the comb conveyor passes the cutting device.

B2. The apparatus of B0, wherein the teeth of the comb conveyor are disposed at least partially above a conveyance surface of the supply conveyor at a selected height.

B3. The apparatus of B2, wherein the height of the teeth above the supply conveyor is adjustable.

B4. The apparatus of B0, further including a shear plate disposed adjacent to the processing conveyance path downstream of the cutting device, the shear plate including an angled surface configured to urge a remaining portion of the impaled piece of produce free from the teeth as the comb conveyor traverses the angled surface.

B5. The apparatus of B0, wherein the supply conveyor conveys at a first conveyance speed, and the comb conveyor conveys at a second conveyance speed different from the first conveyance speed.

B6. The apparatus of B0, further including a return conveyor defining a return conveyance path generally parallel and opposite to the supply conveyance path, the return conveyor configured to circulate produce not impaled on the teeth from an exit portion of the supply conveyor to an entrance portion of the supply conveyor.

C0. A strawberry capper comprising:
a first conveyor having a substantially planar conveyance surface travelling along a first conveyance path;
a second conveyor laterally adjacent to the first conveyor, the second conveyor having a plurality of spaced-apart elongate projections travelling along a second conveyance path parallel to and co-directional with the first conveyance path, each adjacent pair of the elongate projections configured to retain a strawberry impaled therebetween; and
a rotating cutter disposed at a downstream end portion of the second conveyor and spaced from the elongate projections such that rotation of the cutter removes a predetermined amount of the strawberry as the teeth pass by the cutter.

C1. The capper of C0, wherein the elongate projections of the second conveyor overhang a portion of the conveyance surface of the first conveyor at a height corresponding to the predetermined amount of strawberry to be removed.

C2. The capper of C1, wherein the cutter is disposed below the second conveyor.

C3. The capper of C0, further including an angled wall downstream of the cutter, the wall having a slot through which the second conveyor travels, wherein the angled wall is configured to urge an uncut portion of the strawberry off of the elongate projections.

C4. The capper of C0, wherein the cutter defines a cutting direction transverse to the second conveyance direction and generally toward the second conveyor.

D0. The system of any other numbered paragraph, each one of the plurality of elongate teeth having a long axis running from a base portion to a tip portion transverse to the first conveyance path.

D1. The system of any other paragraph, wherein the cutter is rotatable.

D2. The system of any other paragraph, wherein the cutter is configured to remove desired portions of the pieces of produce retained by the teeth.

D3. The system of any other paragraph, wherein the second conveyor includes a planar conveyance surface.

D4. The system of any other paragraph, wherein one or more of the conveyance paths are generally linear.

D5. The system of any other paragraph, wherein one or more of the conveyance paths is generally curved.

D6. The system of any other paragraph, wherein the blade and axis of rotation of a rotatable blade assembly are disposed entirely below the first conveyance path.

D7. The system of any other paragraph, further including a receptacle disposed below the blade assembly, the receptacle configured to receive portions of produce removed by the blade assembly, and including an auger configured to transport the portions of produce through the receptacle to a destination container.

D8. The system of any other paragraph, wherein the comb conveyor and the supply conveyor move at different conveyance speeds.

D9. The system of any other paragraph, further including a fixed shear plate adjacent to the processing conveyor downstream of the blade assembly, a shear surface of the shear plate spanning the processing conveyor and configured to free retained produce from the plurality of teeth as the processing conveyor passes by.

D10. The system of any other paragraph, wherein the teeth of the comb conveyor are disposed above the conveyance surface of the supply conveyor at a height corresponding to the portion to be removed by the cutting system.

D11. The system of any other paragraph, wherein the supply conveyor has a conveyance direction generally the same as a conveyance direction of the processing conveyor.

D12. The system of any other paragraph, wherein the elongate projections of the teeth are generally parallel to the planar conveyance surface of the supply conveyor.

### CONCLUSION

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible.

The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

1. An apparatus for mechanically removing portions of individual pieces of produce, the apparatus including:
a linear first conveyor defining a conveyance path, an upstream end portion and a downstream end portion and configured to transport pieces of produce from the upstream end portion to the downstream end portion;
a linear comb conveyor including a plurality of elongate pointed spikes spaced from each other at substantially regular intervals along a processing path parallel to the conveyance path and configured to impale and retain a piece of the produce in a selected orientation between each pair of adjacent pointed spikes; and
a blade assembly disposed at the downstream end portion of the first conveyor and including a cutting edge configured to pass generally parallel to the elongate pointed spikes at a selected distance such that a desired portion of each piece of the retained produce is removed by the cutting edge.

2. The apparatus of claim 1, further including a second conveyor parallel to the first conveyor, the second conveyor configured to transport pieces of produce not retained by the pointed spikes from the downstream end portion of the first conveyor back to the upstream end portion of the first conveyor.

3. The apparatus of claim 1, further comprising a third conveyor adjacent and parallel to the first conveyor, the third conveyor configured to transport pieces of produce on a planar conveyance surface alongside the first conveyor.

4. The apparatus of claim 3, wherein long axes of the plurality of elongate pointed spikes are oriented generally parallel to the conveyance surface of the third conveyor.

5. The apparatus of claim 3, wherein the plurality of elongate pointed spikes at least partially overhang the conveyance surface of the third conveyor.

6. The apparatus of claim 1, wherein the blade assembly is rotatable.

7. The apparatus of claim 6, wherein an axis of rotation of the blade assembly is parallel to the cutting edge.

8. The apparatus of claim 1, wherein the cutting edge of the blade assembly is configured to pass through each piece of retained produce generally toward proximal ends of the pointed spikes.

9. An apparatus for processing produce, the apparatus comprising:
a linear supply conveyor for conveying produce, the supply conveyor defining a supply conveyance path;
a linear comb conveyor adjacent to the supply conveyor, the comb conveyor including a plurality of pointed spikes spaced apart along a length of the comb conveyor, the comb conveyor configured to transport a plurality of pieces of produce each impaled onto one or more of the pointed spikes along a processing conveyance path generally parallel to the supply conveyance path; and
a cutting device disposed at one end of the comb conveyance path, the cutting device including at least one cutting surface configured to remove a portion of each impaled piece of produce by passing a selected distance from the pointed spikes of the comb conveyor.

10. The apparatus of claim 9, wherein the cutting device is further configured such that each pointed spike of the comb conveyor is passed by at least one cutting surface as the comb conveyor passes the cutting device.

11. The apparatus of claim 9, wherein the pointed spikes of the comb conveyor are disposed at least partially above a conveyance surface of the supply conveyor at a selected height.

12. The apparatus of claim 11, wherein the height of the pointed spikes above the supply conveyor is adjustable.

13. The apparatus of claim 9, further including a shear plate disposed adjacent to the processing conveyance path downstream of the cutting device, the shear plate including an angled surface configured to urge a remaining portion of the impaled piece of produce free from the pointed spikes as the comb conveyor traverses the angled surface.

14. The apparatus of claim 9, wherein the supply conveyor conveys at a first conveyance speed, and the comb conveyor conveys at a second conveyance speed different from the first conveyance speed.

15. The apparatus of claim 9, further including a return conveyor defining a return conveyance path generally parallel and opposite to the supply conveyance path, the return conveyor configured to circulate produce not impaled on the pointed spikes from an exit portion of the supply conveyor to an entrance portion of the supply conveyor.

16. A strawberry capper comprising:
a linear first conveyor having a substantially planar conveyance surface travelling along a linear first conveyance path;
a linear second conveyor laterally adjacent to the first conveyor, the second conveyor having a plurality of spaced-apart elongate pointed spikes travelling along a linear second conveyance path parallel to and co-directional with the first conveyance path, each adjacent pair of the elongate pointed spikes configured to retain a strawberry impaled therebetween; and
a rotating cutter disposed at a downstream end portion of the second conveyor and spaced from the elongate pointed spikes such that rotation of the cutter removes a predetermined amount of the strawberry as the pointed spikes pass by the cutter.

17. The capper of claim 16, wherein the elongate pointed spikes of the second conveyor overhang a portion of the conveyance surface of the first conveyor at a height corresponding to the predetermined amount of strawberry to be removed.

18. The capper of claim 17, wherein the cutter is disposed below the second conveyor.

19. The capper of claim 16, further including an angled wall downstream of the cutter, the wall having a slot through which the second conveyor travels, wherein the angled wall is configured to urge an uncut portion of the strawberry off of the elongate pointed spikes.

20. The capper of claim 16, wherein the cutter defines a cutting direction transverse to the second conveyance direction and generally toward the second conveyor.
